(19) United States
(12) Patent Application Publication
(10) Pub. No.: US 2023/0315412 A1
(43) Pub. Date: Oct. 5, 2023

(54) SCALABLE BEHAVIORAL INTERFACE SPECIFICATION CHECKING

(71) Applicant: Microsoft Technology Licensing, LLC, Redmond, WA (US)

(72) Inventor: John Lawrence SINGLETON, Winter Park, FL (US)

(21) Appl. No.: 17/708,611

(22) Filed: Mar. 30, 2022

(51) Int. Cl. G06F 8/41; G06F 8/30; G06F 8/20

(52) U.S. Cl. CPC G06F 8/447; G06F 8/24; G06F 8/315

(57) ABSTRACT

A computer system is configured to analyze a codebase containing source code and specification of intended behavior of at least a portion of the source code. The analysis of the codebase identifies a callsite of a method within the codebase, obtains a set of bounds associated with one or more parameters being passed to the method at the callsite, and identifies a set of specification associated with the method. The set of specification includes at least a precondition specifying an intended behavior of the method. The method is then analyzed based on the set of specifications and the set of bounds to determine whether the method deviates from the intended behavior specified by the precondition. The computer system then visualizes a result based on analyzing the method.

### BACKGROUND

Behavioral specifications or annotations can be used by programmers to describe behavioral relations between parameters of a method or behavioral relations between methods. By specifying the behavior of a program, a programmer can program adaptively, so that the program is easier to debug and evolve.

Several existing tools provide behavioral specification in a variety of languages, such as, the Java Modeling Language, Eiffel, SPARK/Ada, Spec#, and the like. These existing tools generally provide two methods for checking specifications. One method is based on Runtime Assertion Checking (RAC), and the other method is based on Extended Static checking (ESC). Both RAC and ESC have their pros and cons.

For example, RAC translates a specification into assertions that run during execution. An assertion is a predicate connected to a point in the program, that should evaluate to be true at that point in code execution when the code executes as expected. Assertions can help a programmer read the code, help a compiler compile it, or help the program detect its own defects. However, depending on the assertions, this method can result in performance issues and unsafe code being executed in production.

ESC is a range of techniques for statically checking the correctness of various program constraints. ESC is often performed at compile time. ESC can identify a range of errors, such as division by zero, array out of bounds, integer overflow, null dereferences, etc. Unlike RAC, ESC does not require the program to be run. However, ESC often requires extensive specification from expert users, which makes ESC costly and often unfeasible for all but the most safety-critical code.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The principles described herein are related to a computer system configured to access a codebase containing a source code and specification of an intended behavior of at least a portion of the source code. The computer system is also configured to identify a callsite within the codebase. The callsite calls a function. In response to identifying the callsite, the computer system then obtains a set of bounds associated with one or more parameters that are passed to the method at the callsite. The computer system also identifies a set of specification associated with the method. The set of specifications includes at least a precondition specifying an intended behavior of the method. The computer system then analyzes the method based on the set of specification and the set of bounds to determine whether the method exhibits at least the intended behavior specified by the precondition, and visualizes a result of the analysis.

In some embodiments, the precondition is associated with an argument or a return value of the method. In some embodiments, the precondition is associated with a relationship between an argument of the method and the return value of the method. In some embodiments, the precondition is associated with a relationship between an argument or a return value of the method and an argument or a return value of another method.

In some embodiments, obtaining the set of bounds associated with one or more parameters being passed to the method at the callsite includes identifying one or more first parameters required to call the method, mapping the one or more first parameters to one or more second parameters in local scope, and obtaining a set of bounds associated with the one or more second parameters in the local scope.

In some embodiments, the computer system is further configured to generate a code database based on the codebase. Identifying the callsite, obtaining the set of bounds, and/or identifying the set of specification are performed by querying the code database.

In some embodiments, the codebase is a target codebase, and the computer system is also configured to access one or more supporting codebases that contain source code and specification of functions that are called by the target codebase. In some embodiments, a target code database is generated based on the target codebase, and a supporting code database is generated based on each of the one or more supporting codebases. Identifying the callsite, obtaining the set of bounds, and/or identifying the set of specification are performed by querying both the source code database and the one or more supporting code databases.

In some embodiments, the computer system is further configured to receive a user indication, specifying a path to the one or more supporting codebases, or a path to one or more supporting code databases, where identifying the set of specification associated with the method includes querying the target code database and the one or more supporting code databases.

In some embodiments, the computer system is further configured to receive a user indication, specifying a path to the one or more supporting codebases, or a path to one or more supporting code databases to include the one or more supporting codebases for identifying the set of specification associated with the method.

The principles described herein are also related to a method implemented at a computer system for analyzing a codebase containing source code and specification of intended behavior of at least a portion of source code to determine whether a function exhibits an intended behavior specified by the specification. The method includes identifying a callsite of a function within the codebase, obtaining a set of bounds associated with one or more parameters being passed to the function at the callsite, and identifying a set of specification associated with the function. The set of specification includes at least a precondition specifying an intended behavior of the function. The function is then analyzed based on the set of specification and the set of bounds to determine whether the function exhibits at least the intended behavior specified by the precondition. In response to determining that the function deviates from the intended behavior, a notification is generated.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates an example architecture of a code analysis engine that implements the principles described herein;

FIG. 2 illustrates example source code of a function including specification that specifies preconditions associated with an argument and/or a return value of the function;

FIG. 3A illustrates an example dataflow of a code analysis engine that is configured to generate a code database based on a codebase and perform queries against the code database;

FIG. 3B illustrates an example function add that is called at a callsite within a codebase;

FIG. 3C illustrates an example function okFunction that includes a line of code that calls the function add of FIG. 3B;

FIG. 4 illustrates an example architecture of a code analysis engine that is further configured to obtain additional code databases, on which a target code database may depend;

FIG. 5 illustrates a flowchart of an example method for analyzing a codebase to determine that a function exhibits an intended behavior specified by specification;

FIG. 6 illustrates an example user interface that includes a code editor and a terminal configured to output a result generated by a code analysis engine;

FIG. 7 illustrates a flowchart of an example case study based on a few sample codebases that depend on date portions of a basic development environment (BDE) library; and

FIG. 8 illustrates an example computer system in which the principles described herein may be employed.

### DETAILED DESCRIPTION

The principles described herein provide a mechanism for annotating code written in any language with lightweight behavioral specification, a mechanism for allowing a database under analysis to be augmented with specification that contains additional information about the specification contained on methods, and a scalable and fully automatic enforcement mechanism that requires minimum specification authoring to a method.

Unlike methods that perform modular static verification, which requires translating an entire procedure into “proof form” and checking it with a solver, the principles described herein allow a database under analysis to have the specification of APIs checked at a callsite. In some embodiments, the principles described herein may be accomplished through a range analysis capabilities built in an existing code analysis engine (e.g., but not limited to CodeQL). Not only is this approach scalable, but it is also much more feasible in terms of the ability to automatically check programs without excessive specification and expert intervention.

There are several existing tools that provide behavioral specification in a variety of languages, such as (but not limited to) the Java Modeling Language, Eiffel, SPARK/Ada, and Spec#. These existing tools generally provide one or two methods for checking specification. One method is through Runtime Assertion Checking (RAC), and the second method is Extended Static checking (ESC). RAC translates the specification into assertions that run during execution. Depending on the assertion, this method can result in performance issues and unsafe code being executed in production. ESC does not require that the program is run, but it often requires extensive specification, such as (but not limited to) adding loop invariants and modeling objects, before the procedure can be verified. This makes ESC unfeasible for all but the most safety-critical code.

The principles described herein solve the above-described problems by providing a code analysis engine that combines range analysis with behavioral specification, and looks at the callsites of methods guarded with specification for enforcement. In this way, insight can be gained from static analysis in a way that scales and can work on any program that compiles without requiring extensive program modification or specification.

In some embodiments, the code analysis engine is configured to generate a code database based on the codebase, and the code database can be quried to check specification of source code. In some embodiments, simply adding the specification will ensure the code analysis engine will check it via queries.

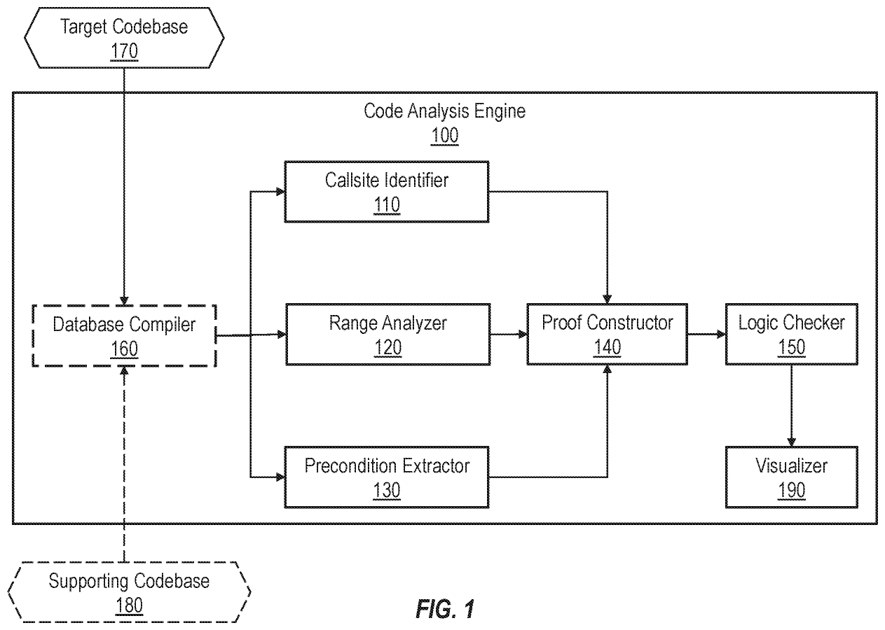

FIG. 1 illustrates an example architecture of a code analysis engine 100 configured to analyze a target codebase 170. The code analysis engine includes a callsite identifier 110, a range analyzer 120, a precondition extractor 130, a proof constructor 140, a logic checker 150, and a visualizer 190. The callsite identifier 110 is configured to identify a callsite of a method (or a function) within the target codebase 170. The range analyzer 120 is configured to obtain a set of bounds associated with one or more parameters that are passed to the method (or the function) at the callsite.

Note, the code analysis engine 100 described herein is capable of analyzing functions and/or methods, depending on the programming paradigms and/or programming languages are used in the codebase. Thus, hereinafter, the term “method” and “function” are used interchangeably.

The precondition extractor 130 is configured to identify a set of specification associated with the method that includes at least a precondition specifying an intended behavior of the method. In some embodiments, the precondition is associated with an argument of the method. In some embodiments, the precondition is associated with a return value of the method. In some embodiments, the precondition is associated with a relationship between an argument of the method and a return value of the method. In some embodiments, the precondition is associated with a relationship between an argument or a return value of the method and an argument or a return value of another method.

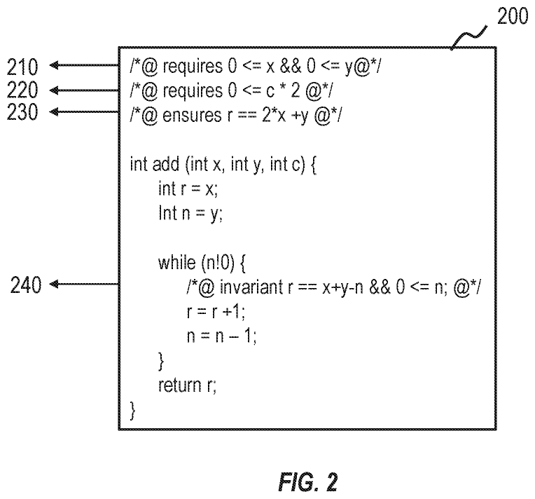

FIG. 2 illustrates example source code 200 of a function add including specification 210, 220, 230, 240 that specifies preconditions, postconditions, and/or loop invariants associated with an argument and/or a return value of the function. The specification 210, 220 starts with the keyword “requires”, generally indicating that it is a precondition, specification 230 starts with the keyword “ensures”, generally indicating that it is a postcondition, and specification 240 starts with the keyword “invariant”, generally indicating that it is a loop invariant. For example, the specification 210 states “0<=x && 0<=y”, and specification 220 states “0<=c*2”, which are preconditions associated with argument x, y, and c of the function add. As another example, specification 210 states “r==2*x+y”, which is a postcondition associated with a relationship between arguments x and y and a return value r of the function add. Specification 240 is a loop invariant that specifies a relationship between arguments x, y, and a return value r.

The proof constructor 140 is configured to construct a proof based on the precondition and the set of bounds for determining whether the method (or the function) deviates from the intended behavior specified by the precondition. The logic checker 150 is configured to check the logic of the proof constructed by the proof constructor 140 to determine whether the method (or the function) deviates from the intended behavior. The visualizer 190 is configured to visualize a result of the logic checker 150.

In some embodiments, the code analysis engine 100 also includes a database compiler 160 configured to compile a code database (also referred to as a target code database) based on the target codebase 170. The callsite identifier 110, the range analyzer 120, and the precondition extractor 130 are configured to query the code database to identify a callsite of a method, obtain a set of bounds associated with the one or more parameters that are passed to the method, and/or identify a set of specification associated with the method.

In some embodiments, the code analysis engine 100 is also configured to access one or more supporting codebases 180 that contains source code and/or specification of the method that is called by the target codebase. The database compiler 160 is also configured to generate a supporting code database for each of the one or more supporting codebases 180. The range analyzer 120 and the precondition extractor 130 are further configured to query the supporting code database to obtain a set of bounds associated with the one or more parameters that are passed to the method, and/or identify a set of specification associated with the method.

In some embodiments, the code analysis engine 100 allows a user to specify a path to the one or more supporting codebases 180 or a path to the one or more supporting code databases, such that the code analysis engine 100 will include the supporting codebases 180 in the analysis.

In some embodiments, the callsite identifier 110 is configured to identify one or more callsites of the method from the target codebase. For each identified callsite, the range analyzer 120 is configured to obtain a set of bounds associated with the one or more parameters that are passed to the method at the corresponding callsite, and the precondition extractor 130 is configured to analyze the method based on the set of specification and the set of bounds to determine whether the method violates the at least the intended behavior specified by the precondition. In some embodiments, a user can specify a particular method that is to be analyzed at its callsites.

In some embodiments, the database compiler 160 is an existing commercial database compiler, such as (but not limited to) CodeQL. The codebase can include code written in a plurality of programming languages, such as (but not limited to) C, C++, C#, Go, Java, JavaScript, Python, Ruby, and/or TypeScript. In some embodiments, when the codebase includes code written in a plurality of programming languages, a separate code database is generated for each of the plurality of programming languages.

In some embodiments, a user is given an option to turn on the specification analysis tool within the code analysis engine, such that the specification is automatically checked at callsites. In some embodiments, once the option is turned on, all the callsites of all the functions are checked. Alternatively or in addition, users are given an option to specify a particular callsite of a particular method to be checked. Alternatively, or in addition, users are given an option to specify a particular function, causing all the callsites of the particular function to be checked. Alternatively, or in addition, users are given an option to specify a type of function, causing all the callsites of the type of functions to be checked.

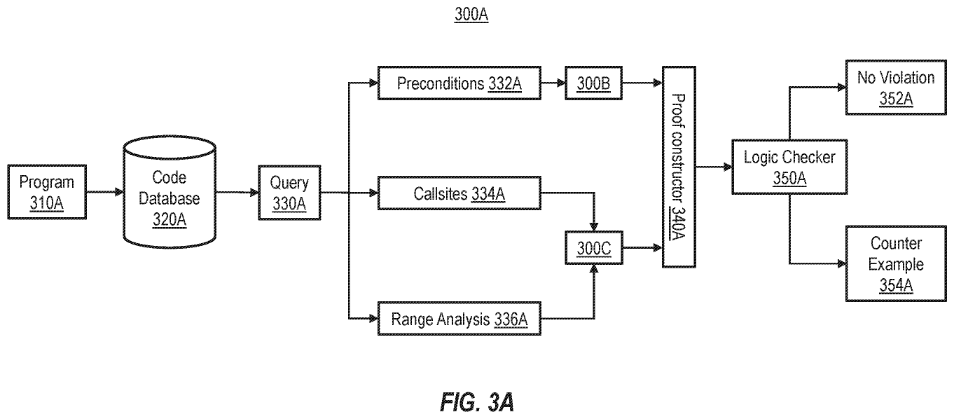

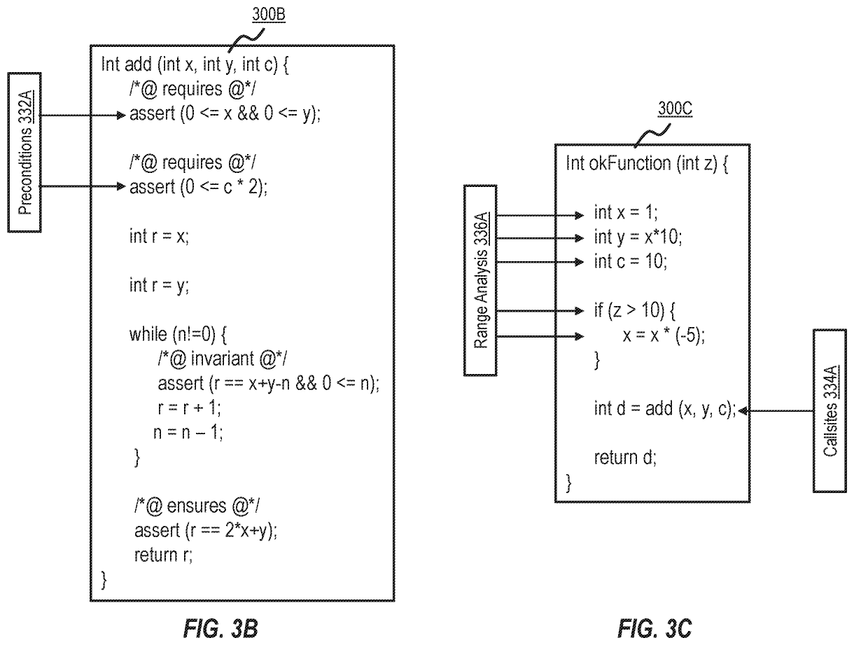

FIG. 3A illustrates an example dataflow of a code analysis engine 300A that is configured to generate a code database based on a codebase and to perform queries against the code database. As illustrated in FIG. 3A, a program 310A under analysis is compiled to a code database 320A. The code database 320A is then queried 330A to identify callsites 334A of a method, and obtain specification (that specifies preconditions 332A) of the method. For example, if method okFunction 300C calls method add 300B and add 300B has specification that specifies a precondition, the specification of add 300B is extracted.

FIG. 3B illustrates an example function add 300B. FIG. 3C illustrates an example okFunction 300C. As illustrated, okFunction 300C has a line of code “int d=add (x, y, c)”, which is a callsite 334A that calls function add 300B. Based on the identified callsite 334A, the range analysis 336A can be performed.

In some embodiments, range analysis 336A further includes extracting the one or more parameters being passed to the function. In some embodiments, extracting the one or more parameters being passed to the function includes identifying one or more first parameters required to call the function, and mapping the one or more first parameters to one or more second parameters in a local scope. For example, at the callsite 334A, the function add (x, y, c) is called. The one or more first parameters required to call the function include x, y, and c. The one or more first parameters x, y, and c are then mapped to second parameters in a local scope. Here, based on function okFunction, x may be 1 or 5 depending on whether z is greater than 10. As such, the second parameters in a local scope include x=1 or 5, y=x *10=10, and c=10. The range analysis can then be performed based on the parameters in the local scope to determine the bounds of the one or more second parameters. For example, in the case of the callsite 334A, the bounds include (1) −5<=x<=1, (2) 10<=y<=10, and (3) 10<=c<=10.

In some embodiments, in addition to just straight checking the preconditions, the range analysis 336A is configured to be iteratively augmented as it learns more about possible values based on the preconditions and postconditions of the methods it is checking. For example, if it is known that the function add returns a value larger than either of the arguments, it is known that any value the function add assigns to will also be larger than either of the two operands.

Further, also based on the identified callsite 334A, the specification associated with the function add 300B is identified. As illustrated, the specification includes two preconditions, “0<=x && 0<=y” and “0<=c*2”.

With the above pieces of information, including (1) preconditions 332A of the called function add 300B, (2) parameters, x=1 or 5, y=x *10=10, and c=10, being passed to the method, and (3) bounds 1<=x<=5, 10<=y<=10, and 10<=c<=10, a proof is constructed by the proof constructor 340A for checking the preconditions. In some embodiments, the proof is constructed based on Satisfiability Modulo Theories (SMT). The proof is then checked by a logic checker to determine whether the method exhibits at least the intended behavior specified by the precondition. In some embodiments, the logic checker 350A is an SMT solver, such as (but not limited to) Z3, configured to solve the constructed proof. Depending on the circumstances, the logic checker 350A may determine that there is no violation 352A based on solving the SMT proof, or determine that there is a counter example 354A that violates the preconditions 332A. The determination of no violation 352A or counter example 354A can then be output for a user to review.

In some embodiments, when a target code database is analyzed with a query, the scope of the analysis is not limited to the code contained within that database. In some embodiments, the code analysis engine is further configured to check specification of not only within a target codebase but within additional codebases, on which the target codebase depends. These additional codebases are also referred to as supporting codebases.

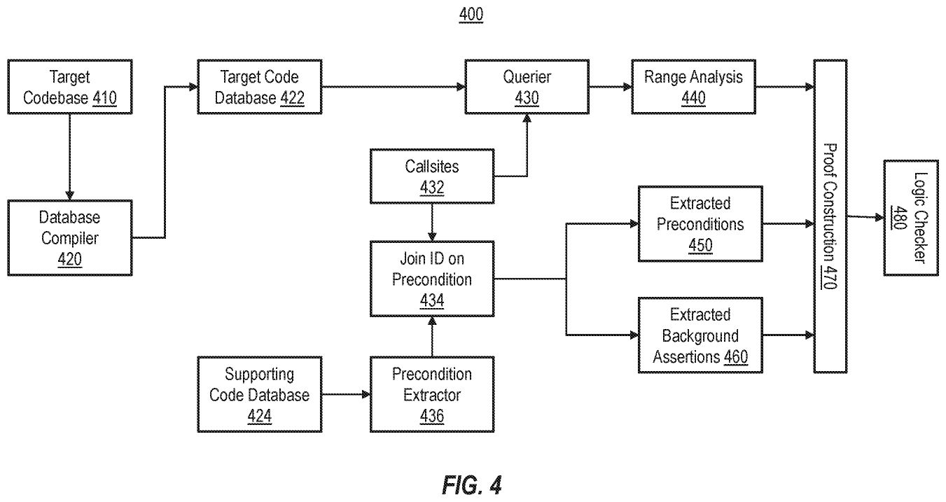

FIG. 4 illustrates an example architecture of a code analysis engine 400 that is further configured to obtain supporting code databases 424 on which a target code database 422 may depend.

As illustrated in FIG. 4, the code analysis engine 400 includes a database compiler 420 configured to compile target codebase 410 into a target code database 422. The code analysis engine 400 also has access to one or more supporting code databases 424. In some embodiments, the supporting code databases are existing databases, such as, but not limited to, specification databases, that have been compiled by the database compiler 420 or a different database compiler earlier.

The code analysis engine 400 includes a precondition extractor 436 configured to extract preconditions and background assertions from the supporting code database(s) 424. The code analysis engine 400 also includes a querier 430 configured to generate and perform a set of queries. The set of queries includes a query to obtain callsites 432. The identifier of the method (that is called at the callsites) is then joined 334 with the identifier of the method associated with the preconditions and background assertions extracted by the precondition extractor 436. Based on the joint identifier on the precondition of the method in the supporting code database and the method at the call site, the preconditions 450 and/or background assertions 460 associated with the method are extracted.

The set of queries also includes a query configured to perform range analysis 440. The result of the range analysis 440, the extracted preconditions 450, and the extracted background assertions 460 are then used to perform proof construction 470. The constructed proof is then sent to a logic checker (not shown) to determine whether the method called at the callsite has no violation or whether a counter example can be found.

In some embodiments, a programmer can choose at least one of the following options (1) an option to turn on the specification analysis tool within the code analysis engine, and/or (2) an option to specify a path to one or more code databases that should be included for the purposes of the specification analysis. The specification analysis tool includes the callsite identifier 110, range analyzer 120, precondition extractor 130, proof constructor 140, logic checker 150, and/or visualizer 190 illustrated in FIG. 1, and/or the functions performed at blocks 330A, 340A, 350A of FIG. 3A, and blocks 430, 436, 434, 440, 470, and 480 of FIG. 4.

In some embodiments, using these two options, the code analysis engine 400 is configured to (1) invoke a driver script that implements the specification analysis tool, and (2) for each supporting database, the specification analysis engine examines procedures for specification information. These specifications are extracted from the source database and translated to a library file that encodes the specification, background assertions, and identifiers necessary for creating proofs later in the verification process. The specification analysis tool then extracts the callsites from the target code database, and extracts specification associated with the function(s) called at the callsites from the target code database or supporting code database that has the specification and selected in the options. If the specification is local, meaning the specification is attached to a procedure within the database under analysis, it is analyzed without having to be added as a specification database. for each callsite to a method guarded by a precondition, the code analysis engine extracts the precondition of the called method.

In some embodiments, the datafiles may be packaged within the specification databases in CSV format. The parameters required to call the method are identified and mapped to parameters in the local scope. The bounds on each parameter that are passed to the method are extracted. Thereafter, the code analysis engine constructs a proof for checking the preconditions. The proof is then checked by a logic checker to determine whether the method exhibits at least the intended behavior specified by the precondition. If a counter example is found, the method is flagged as having a potential violation. In some embodiments, the parameters necessary to construct the counter example are provided to the user.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

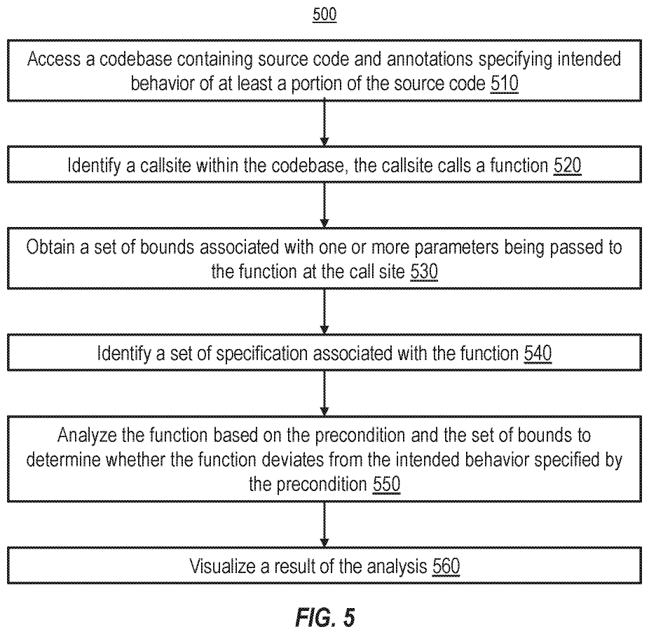

FIG. 5 illustrates a flowchart of an example method 500 for analyzing a codebase to determine that a function exhibits an intended behavior specified by specification. The method 500 includes accessing the codebase that contains source code and specification of intended behavior of at least a portion of source code (act 510). The method 500 also includes identifying a callsite within the codebase (act 520). The callsite calls a function. The method 500 further includes obtaining a set of bounds associated with one or more parameters being passed to the function at the call site (act 530).

The method 500 also includes identifying a set of specification associated with the function (act 540). The set of specification includes at least a precondition specifying an intended behavior of the function. In some embodiments, the precondition is associated with an argument of the function. In some embodiments, the precondition is associated with a return value of the function. In some embodiments, the precondition is associated with a relationship between an argument of the function and a return value of the function. In some embodiments, the precondition is associated with a relationship between an argument or a return value of the function and an argument or a return value of another function.

The method 500 further includes analyzing the function based on the precondition and the set of founds to determine whether the function deviates from the intended behavior (act 550), and a result of the analysis is visualized (act 560). For example, when a violation is found, one or more counter examples that deviates from the intended behavior can be presented to a user.

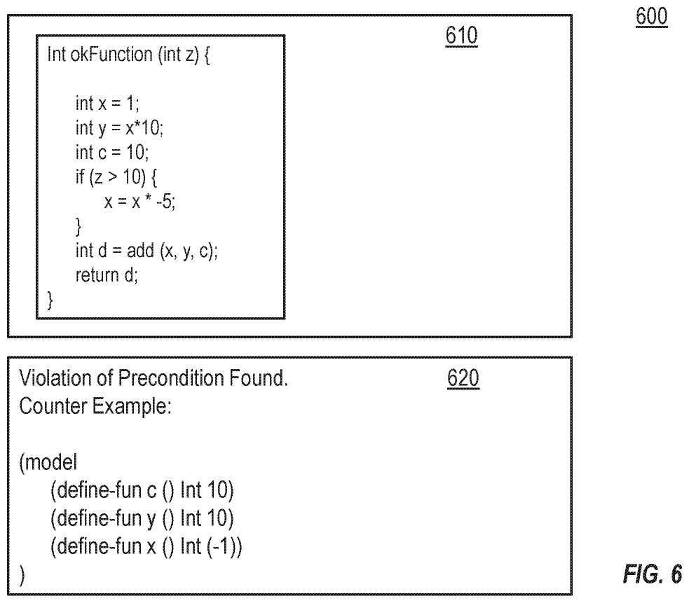

FIG. 6 illustrates an example user interface 600, including an editor 610 and a terminal 620. A user can edit code in the editor 610. When the code in the editor section is run, the terminal section outputs or visualizes a result of code analysis. The terminal 620 is an example of a visualizer 190 of FIG. 1. When the function okFunction is run, a violation of a precondition is found, and the result of a finding of the violation and a counter example that violated the precondition is displayed in the terminal 620. As illustrated, the counter example in this case is a set of parameters that are passed to the function add, namely x=−1, y=10, and c=10.

Assuming the add function is the add function shown in FIG. 3B. Referring back to FIG. 3B, the precondition 332A requires that “0<=x && 0<=y”. Here, the bounds of x is −1<=x<=5, and one of the values in the bounds of x is x=−1, which violates the precondition of 0<=x. Thus, a violation is found, and the counter example is identified.

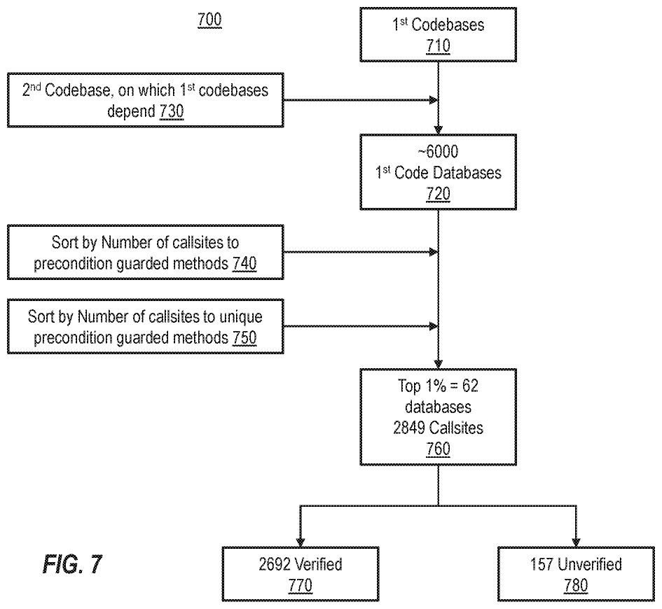

FIG. 7 illustrates a flowchart of an example case study 700 based on a few first codebases 710 that depend on date portions of a second codebase. The case study 700 demonstrates that the principles described herein are capable of providing scalable code analysis that is not possible based on the existing technologies.

As illustrated in FIG. 7, within the few first codebases, first code databases are created for each of them, which yielded approximately 6000 first databases (block 720). Within each database, the callsites to methods within the second codebase that contained preconditions are examined (block 730). In the study case, the analysis is restricted to preconditions containing simple arithmetic and logical expressions, and preconditions containing references to numeric and Boolean datatypes. Each such callsites are analyzed with a method within the second codebase. To ensure diverse results, each database is ranked by the number of such callsites (block 740) and then by the number of unique calls (block 750). A unique call is defined as a call a distinct method within the second codebase. For example, if the first codebases called a particular function in the second codebase 100 times that would be scored as 100 callsites but 1 unique call. From this list of ranked databases, top 1% of the databases (=62) are identified. These databases yielded 2849 callsites for analysis (block 760).

Each callsite is examined to determine if violations to the precondition present. In evaluating the precondition analysis tool, it is found that 2692 preconditions (block 770) were able to be checked automatically and found to be free from violations, which is 95% of all the callsites that are examined. On average, approximately 5% of callsites per database are found to have possible violations for a total of 157 violations (block 780) across the 62 databases. These violations are likely mistakes made by programmers, and not found by existing debugging tools. As such, it is demonstrated that the principles described herein improve the function of the computer system and the field of software development by efficiently and reliably detecting programming errors.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

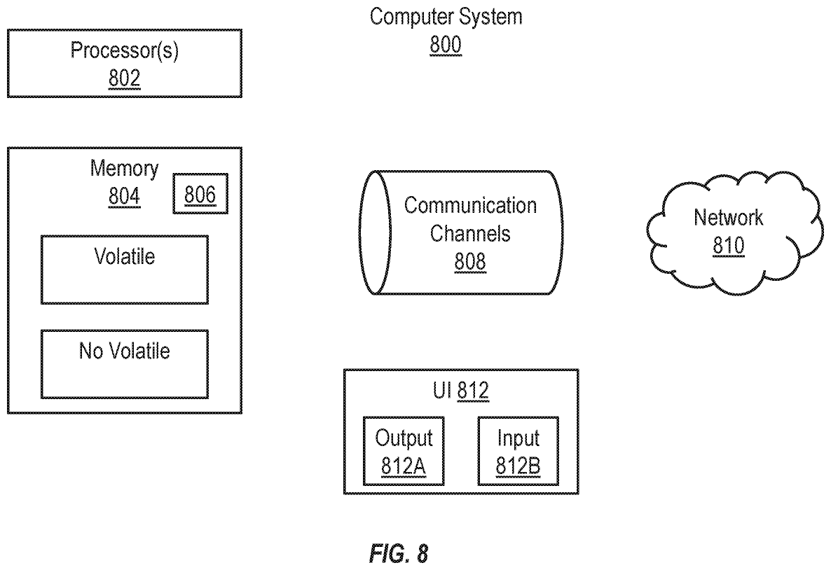

Finally, because the principles described herein may be performed in the context of a computer system (for example, the code analysis engine 100, 300A in FIGS. 1 and 3A are computer systems) some introductory discussion of a computer system will be described with respect to FIG. 8.

Computer systems are now increasingly taking a wide variety of forms. Computer systems may, for example, be hand-held devices, appliances, laptop computers, desktop computers, mainframes, distributed computer systems, data centers, or even devices that have not conventionally been considered a computer system, such as wearables (e.g., glasses). In this description and in the claims, the term “computer system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computer system. A computer system may be distributed over a network environment and may include multiple constituent computer systems.

As illustrated in FIG. 8, in its most basic configuration, a computer system 800 typically includes at least one hardware processing unit 802 and memory 804. The processing unit 802 may include a general-purpose processor and may also include a field-programmable gate array (FPGA), an application-specific integrated circuit (ASIC), or any other specialized circuit. The memory 804 may be physical system memory, which may be volatile, non-volatile, or some combination of the two. The term “memory” may also be used herein to refer to non-volatile mass storage such as physical storage media. If the computer system is distributed, the processing, memory and/or storage capability may be distributed as well.

The computer system 800 also has thereon multiple structures often referred to as an “executable component.” For instance, memory 804 of the computer system 800 is illustrated as including executable component 806. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computer system, whether such an executable component exists in the heap of a computer system, or whether the executable component exists on computer-readable storage media.

In such a case, one of ordinary skill in the art will recognize that the structure of the executable component exists on a computer-readable medium such that, when interpreted by one or more processors of a computer system (e.g., by a processor thread), the computer system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computer systems. If such acts are implemented in software, one or more processors (of the associated computer system that performs the act) direct the operation of the computer system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 804 of the computer system 800. Computer system 800 may also contain communication channels 808 that allow the computer system 800 to communicate with other computer systems over, for example, network 810.

While not all computer systems require a user interface, in some embodiments, the computer system 800 includes a user interface system 812 for use in interfacing with a user. The user interface system 812 may include output mechanisms 812A as well as input mechanisms 812B. The principles described herein are not limited to the precise output mechanisms 812A or input mechanisms 812B as such will depend on the nature of the device. However, output mechanisms 812A might include, for instance, speakers, displays, tactile output, holograms, and so forth. Examples of input mechanisms 812B might include, for instance, microphones, touchscreens, holograms, cameras, keyboards, mouse or other pointer input, sensors of any type, and so forth.

Embodiments described herein may comprise or utilize a special purpose or general-purpose computer system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computer system.

A “network” is defined as one or more data links that enable the transport of electronic data between computer systems and/or modules and/or other electronic devices. When information is transferred or provided over a network or another communications connection (either hard-wired, wireless, or a combination of hard-wired or wireless) to a computer system, the computer system properly views the connection as a transmission medium. Transmissions media can include a network and/or data links that can be used to carry desired program code means in the form of computer-executable instructions or data structures and which can be accessed by a general-purpose or special-purpose computer system. Combinations of the above should also be included within the scope of computer-readable media.

Further, upon reaching various computer system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computer system RAM and/or to less volatile storage media at a computer system. Thus, it should be understood that storage media can be included in computer system components that also (or even primarily) utilize transmission media.

Computer-executable instructions comprise, for example, instructions and data which, when executed at a processor, cause a general-purpose computer system, special purpose computer system, or special purpose processing device to perform a certain function or group of functions. Alternatively or in addition, the computer-executable instructions may configure the computer system to perform a certain function or group of functions. The computer-executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computer systems, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computer systems which may correspond to the computer system 800 previously described. The computer systems of the remaining figures include various components or functional blocks that may implement the various embodiments disclosed herein, as will be explained. The various components or functional blocks may be implemented on a local computer system or may be implemented on a distributed computer system that includes elements resident in the cloud or that implement aspect of cloud computing. The various components or functional blocks may be implemented as software, hardware, or a combination of software and hardware. The computer systems of the remaining figures may include more or less than the components illustrated in the figures, and some of the components may be combined as circumstances warrant. Although not necessarily illustrated, the various components of the computer systems may access and/or utilize a processor and memory, such as processing unit 802 and memory 804, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable hardware storage devices having stored thereon computer-executable instructions that are structured such that, when the computer-executable instructions are executed by the one or more processors, the computer system is configured to:
access a codebase containing source code and specification of intended behavior of at least a portion of the source code;
identify a callsite within the codebase, the callsite calling a method;
obtain a set of bounds associated with one or more parameters that are passed to the method at the callsite;
identify a set of specification associated with the method, the set of specification including at least a precondition specifying an intended behavior of the method;
analyze the method based on the precondition and the set of bounds to determine whether the method deviates from the intended behavior specified by the precondition; and
visualize a result based on analyzing the method.

2. The computer system of claim 1, wherein the precondition is associated with an argument or a return value of the method.

3. The computer system of claim 1, wherein the precondition is associated with a relationship between an argument of the method and a return value of the method.

4. The computer system of claim 1, wherein the precondition is associated with a relationship between an argument or a return value of the method and an argument or a return value of another method.

5. The computer system of claim 1, wherein obtaining the set of bounds associated with one or more parameters being passed to the method at the callsite comprises:
identifying one or more first parameters required to call the method;
mapping the one or more first parameters to one or more second parameters in a local scope; and
obtaining a set of bounds associated with the one or more second parameters in the local scope.

6. The computer system of claim 1, wherein:
the computer system is further configured to generate a code database based on the codebase; and
identifying the callsite, obtaining the set of bounds, or identifying the set of specification is performed by querying the code database.

7. The computer system of claim 1, wherein the codebase is a target codebase, and
the computer system is further configured to access one or more supporting codebases that contain source code or specification of the method that is called by the target codebase.

8. The computer system of claim 7, wherein:
the computer system is further configured to:
generate a target code database based on the target codebase; and
generate a supporting code database based on each of the one or more supporting codebases; and
identifying the set of specification is performed by querying the target code database and the supporting code database.

9. The computer system of claim 8, wherein:
the computer system is further configured to receive a user indication, specifying a path to the one or more supporting codebases, or a path to one or more supporting code databases, and
identifying the set of specification associated with the method includes querying the target code database and the one or more supporting code databases.

10. The computer system of claim 8, wherein the computer system is further configured to:
identify each callsite of the method from the target codebase;
for each callsite,
obtain a set of bounds associated with one or more parameters that are passed to the method at the callsite;
identify a set of specification associated with the method, the set of specification including at least a precondition specifying an intended behavior of the method; and
analyze the method based on the set of specification and the set of bounds to determine whether the method violates at least the intended behavior specified by the precondition.

11. The computer system of claim 8, wherein the specification are written in an language that can be utilized by language query tool, and the target code database or supporting code database is generated by the language query tool.

12. The computer system of claim 11, wherein the language query tool is caused to augment the target code database of the target codebase with specification obtained from one or more supporting codebases.

13. The computer system of claim 5, wherein the codebase comprises code written in at least one of following programming languages: C, C++, C#, Go, Java, JavaScript, Python, Ruby, or TypeScript.

14. The computer system of claim 5, wherein:
when the codebase comprises code written in a plurality of programming languages, a separate code database is generated for each of the plurality of programming languages.

15. A method implemented at a computer system for analyzing a codebase containing source code and specification of intended behavior of at least a portion of source code to determine whether a function exhibits an intended behavior specified by the specification, the method comprising:
identifying a callsite within the codebase, the callsite calling a function;
obtaining a set of bounds associated with one or more parameters that are passed to the function at the callsite;
identifying a set of specification associated with the function, the set of specification including at least a precondition specifying an intended behavior of the function;
analyzing the function based on the precondition and the set of bounds to determine whether the function deviates from the intended behavior specified by the precondition; and
visualizing a result based on analyzing the function.

16. The method of claim 15, wherein the precondition is associated with an argument or a return value of the function.

17. The method of claim 15, wherein and the precondition is associated with a relationship between an argument of the function and a return value of the function.

18. The method of claim 15, wherein:
the function further comprises generating a code database based on the codebase; and
identifying the callsite, obtaining the set of bounds, or identifying the set of specification is performed by querying the code database.

19. The method of claim 15, wherein the codebase is a target codebase, and
the computer system is further configured to accessing one or more supporting codebases that contain source code or specification of the method that is called by the target codebase.

20. A computer program product comprising one or more hardware storage devices having stored thereon computer-executable instructions that are structured such that, when the computer-executable instructions are executed by one or more processors of a computer system, the computer system is configured to perform:
access a codebase containing source code and specification of intended behavior of at least a portion of the source code;
identify a callsite within the codebase, the callsite calling a method;
obtain a set of bounds associated with one or more parameters that are passed to the method at the callsite;
identify a set of specification associated with the method, the set of specification including at least a precondition specifying an intended behavior of the method;
analyze the method based on the precondition and the set of bounds to determine whether the method deviates from the intended behavior specified by the precondition; and
visualize a result based on analyzing the method.
